(19) United States
(12) Patent Application Publication
(10) Pub. No.: US 2006/0030965 A1
(43) Pub. Date: Feb. 9, 2006

(54) Method and apparatus for automating VLSI modifications made after routing has been performed

(76) Inventors: Brett H. Williams, Windsor, CO (US); Richard S. Rodgers, Fort Collins, CO (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/895,170

(22) Filed: Jul. 20, 2004

(51) Int. Cl. G06F 17/50; G06F 19/00

(52) U.S. Cl. 700/121; 716/1

(57) ABSTRACT

An engineering change order (ECO) tool for automatically making changes to an IC design after the IC design has been placed, routed and verified. The ECO tool is configured to receive a directive or a list of directives and to automatically make modifications described by the directives. The ECO tool of the present invention obviates the need to rebuild the IC design from the netlist up as well as the need to make changes manually using a layout editor.

### BACKGROUND OF THE INVENTION

Integrated circuits (ICs) are designed using very large scale integrated circuit (VLSI) techniques. FIG. 1 illustrates a flow diagram of the current VLSI design process. A placement tool 11 receives as its input a netlist 9 that defines the logical connectivity of the components of the design. It then automatically determines acceptable positions of the components. A routing tool 13 receives as its input a file from the placement tool 11 that indicates the placement of the components. Then, the routing tool connects the components with conductors. Once placement and routing have been performed, one or more verification tools 15 are used to verify the completed design 17 to ensure that the IC will function properly.

Often times it is necessary to make changes to the completed design after it has been successfully verified. When a change to the completed design is called for, an engineering change order (ECO) is issued. When this occurs, the designer is required to analyze the ECO and determine how to implement the changes with minimal impact to the other elements in the design. This requires the designer to investigate the physical design for a way to implement the desired change. If a simple change needs to be made, the designer typically makes the change manually using a layout editor 18 and fill cell resources available in the IC design. It is common for a physical design to be built with potential changes in mind. Prepopulating the physical design with fill cells reserves space and resources for implementing potential design modifications. These cells give the designer options when trying to implement a post-route design change.

The process of making manual changes to a design using the layout editor 18 is difficult, time consuming and error prone. Furthermore, any mistake made by the designer results in the need to correct and reverify the design. Further mistakes often require multiple iterations through the verification processes. If multiple changes need to be made, the designer's capacity to make all of the changes manually may be exceeded. When this happens, the designer is forced to rebuild the entire design by incorporating the design changes into the netlist 9 and rerunning the processes performed by the placement, routing and verification tools 11, 13 and 15. This rebuild process adds substantial time and risk and essentially doubles the design build time. In addition, when the place and route processes are performed again, any previously established confidence in the design is unknown until the verification process is once again completed.

Accordingly, it would be desirable to enable changes to be made to a completed IC design automatically without having to rebuild the design from the netlist up and without having to re-perform the full placement and routing processes on the entire IC design.

### SUMMARY OF THE INVENTION

The present invention provides an engineering change order (ECO) tool for automatically making changes to an IC design after the IC design has been placed, routed and verified. The ECO tool is configured to receive one or more directives, each of which identifies one or more ECO tasks to be performed on the IC design based on an engineering change order (ECO). The ECO tool then automatically performs the tasks identified by the received directives. These tasks may include, for example, placing new design elements, moving an existing design element, deleting existing routes, adding new routes, etc. The ECO tool of the present invention obviates the need to rebuild the IC design from the netlist up as well as the need to make changes manually using a layout editor.

In accordance with the preferred embodiment, when the ECO tool performs the tasks identified by the directives, only those portions of the IC design affected by the tasks are actually modified. This is in contrast to typical placement tools, which automatically perform placement on other portions of the IC design when a particular placement task is performed, even when those other portions of the design are not directly affected by the changes required by the ECO. By not changing the other portions of the IC design not directly affected by performance of the tasks identified by the directives, confidence in the previously placed, routed and verified design is maintained. Only the changed portion of the IC design needs to be routed and verified, although the verification process may be performed on the entire design as modified.

Preferably, routing is only performed on the portion of the IC design affected by the tasks performed by the ECO tool. In accordance with one embodiment, the ECO tool generates a file during the placement process, which subsequently is provided to the routing tool used during the normal routing process. The routing tool then performs routing on the portions of the design affected by the tasks performed by the ECO tool. In accordance with another embodiment, the ECO tool is configured to perform placement and routing and automatically places only those design elements specified by the directives and performs routing only for those nets which have been affected by the changes to the design.

These and other features and advantages of the invention will become apparent from the following description, drawings and claims.

### BRIEF DESCRIPTION OF THE DRAWINGS

FIG. 1 illustrates a flow diagram of the current VLSI process for designing ICs.

FIG. 2 illustrates a flow diagram of the VLSI design process modified in accordance with the present invention to allow changes to a completed IC design to be made automatically.

FIG. 3 illustrates a flow chart of the method of the present invention in accordance with an embodiment for automatically performing placement on an IC design that has previously been placed, routed and verified.

FIG. 4 illustrates a flow chart of the method of the present invention in accordance with an embodiment for locating a placement position for a design element.

### DETAILED DESCRIPTION OF THE PREFERRED EMBODIMENT

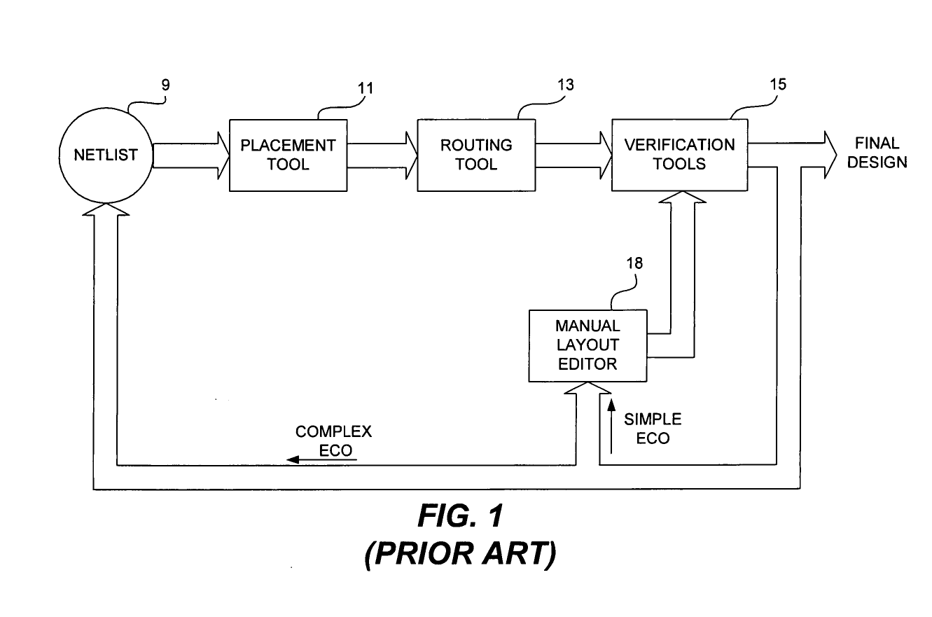

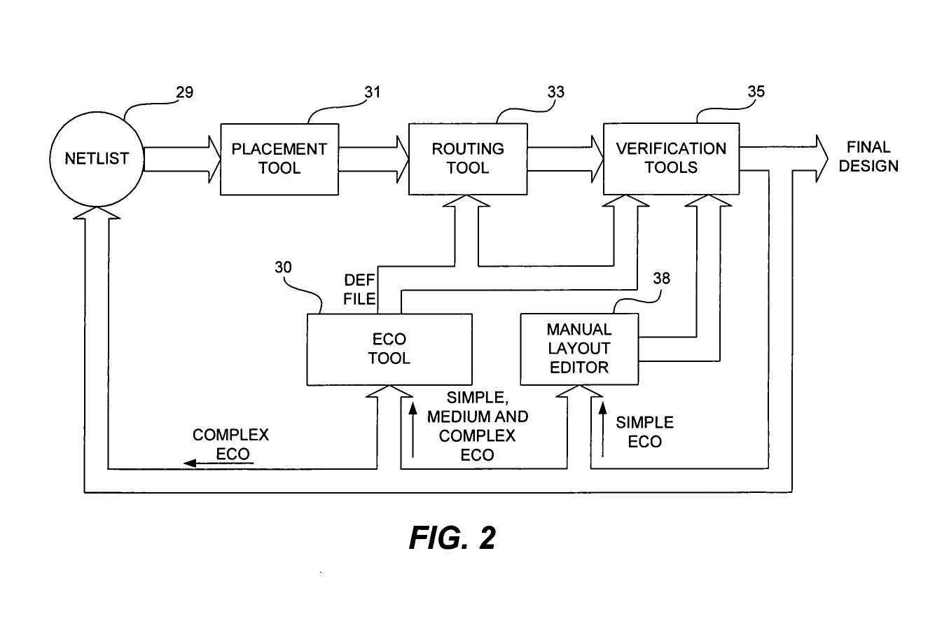

FIG. 2 illustrates a flow diagram of the VLSI design process modified in accordance with the present invention. The invention allows changes to a completed IC design to be made automatically rather than manually with a layout editor, and without having to incorporate the changes into a netlist and re-perform the placement and routing processes. The flow diagram shown in FIG. 2 is similar to the flow diagram shown in FIG. 1 except that it includes the ECO tool 30 of the present invention, which is configured with logic for automatically modifying a completed design. The ECO tool 30 obviates the need to manually edit the layout using a layout editor 38 or to rebuild the design by modifying the netlist 29.

The items labeled 9-18 in FIG. 1 may be identical to the items labeled 29-38 in FIG. 2. Therefore, a detailed description of items 29-38 will not be provided. The ECO tool 30 preferably is a software program that enables designers to make post-route design changes. The ECO tool 30 minimizes changes so that the existing design is impacted as little as possible. This decreases the possibility of making changes that will cause the design to fail quality checks that the design previously passed during the verification process. For example, all routes for nets that are not affected by the requested changes preferably are left untouched by the ECO tool 30. The ECO tool 30 modifies the logical and/or physical design only to the extent necessary in view of the changes indicated in the ECO. The changes made to the logical connectivity are be made in response to directives given by the designer in the form of input to the ECO tool 30. The designer may also specify changes to the physical connectivity of the design through directives given by the designer in the form of input to the ECO tool 30. Alternatively, modifications to the physical connectivity may be made automatically by the ECO tool 30 without any input from the designer. Typically, some of the physical changes will be made by the ECO tool 30 in response to directives given by the designer and others will be made by the ECO tool 30 automatically without any involvement on the part of the designer.

The ECO tool 30 of the present invention gives the designer widely varying levels of control over the placement of new design elements (e.g., gates). In contrast, with current VLSI processes, the designer has very little control over placement because current placement tools perform the placement process on the entire design even when only a portion of the design is modified. Current placement tools are not configured to perform placement on only a portion of the design without modifying other portions of the design.

In accordance with the present invention, the ECO tool 30 is configured to receive both explicit placements from the designer as well as placement “hints”. A placement hint provides a starting point from which to begin looking for a placement location. An explicit placement provides a precise location in the design for the design element to be placed. None of the current placement tools provide such fine-grained control over the placement process. Furthermore, the ECO tool 30 of the present invention preferably automatically performs rule checking after placement to ensure that any placements were made correctly. For example, the ECO tool 30 performs rules checking to detect short circuits and ensures that rerouting of affected nets is performed.

After placement has been performed by the ECO tool 30, routing for the new gates is performed. After routing has been performed, the modified design is verified. In accordance with the preferred embodiment, only incremental routing is performed, i.e., only the connections of the newly added or modified design elements are made. As stated above, the ECO tool 30 leaves all routes in the original completed design that are unaffected by the changes untouched. Preferably, any routing that is performed on the changed portion of the design is performed by the routing tool 33. An alternative to this is to provide the ECO tool 30 with routing capability. The ECO tool 30 preferably generates a design exchange format (DEF) file that is input to the routing tool 33. In accordance with the preferred embodiment, the routing tool 33 is configured to perform routing only on the portion of the IC design that was changed during the placement process performed by the ECO tool 30.

For cases where the modifications called for in the ECO are relatively straightforward, the designer may not need to provide any placement guidance to the ECO tool 30. For cases where the modifications called for are not straightforward, the ECO tool 30 allows the designer to explicitly control gate placement by allowing the designer to enter gate placement directives to the ECO tool 30. As shown in FIG. 2, the ECO tool 30 is capable of performing simple, medium level and complex ECO tasks. Although the ECO tool 30 obviates the need to make changes manually using the layout editor 38, if desired, simple changes may be made using the layout editor 38. Likewise, although the ECO tool 30 obviates the need to rebuild the netlist, changes may be made by rebuilding the netlist if so desired. If routing is performed by the ECO tool 30, the modified design can be sent directly to the verification process. If routing is required after the ECO tool 30 runs, the modified design typically is sent to the routing process and then to the verification process.

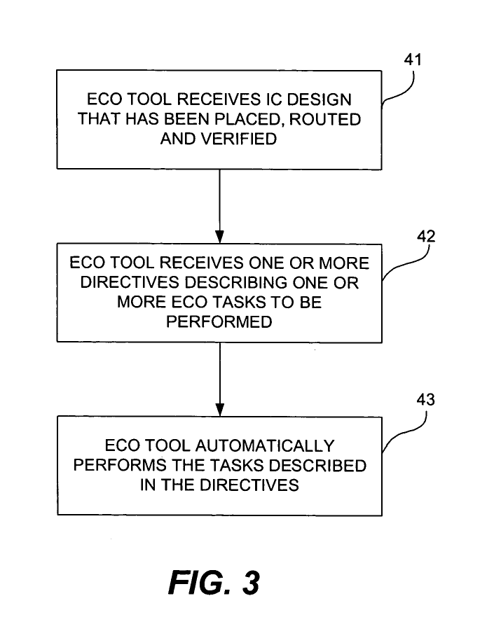

FIG. 3 illustrates a flow chart of the method of the present invention in accordance with an embodiment for automatically making one or more changes to an IC design that has previously been placed, routed and verified. The ECO tool 30 receives an IC design that has already been through the placement, routing and verification processes, as indicated by block 41. The ECO tool 30 also receives a file of directives that describe tasks to be performed by the ECO tool 30 on the IC design, possibly including directives for placement, but also possibly including changes to be made to the logical and/or physical connectivity of the design, as indicated by block 42. The ECO tool 30 then causes the tasks identified by the directives to be automatically performed, as indicated by block 43.

The following is a non-exclusive list of examples of directives that the designer provides as input to the ECO tool 30 of the present invention. It should be noted that the present invention is not limited to the directives listed and that directives may be added or deleted from the list as desired:

1. placement_hint {instname x y}. This directive causes the ECO tool 30 to place the specified instance near the point x, y. The ECO tool 30 then automatically determines exactly where the specified instance will be placed using the hint as a starting point.

2. placement_hint_inst {instname hint_instname}. This directive indicates that the specified instance should be placed near the placement of the instance named ‘hint_instname’. If the hint_instname refers to a relevant fill cell, this results in that fill cell being chosen as the one to be replaced. This directive results in the tightest control over gate placement.

3. add_connection {pin1 pin2}. This directive causes the ECO tool 30 to add a connection between pins 1 and 2. If no net is connected to either pin, a new net will be created by the ECO tool 30. If both pins are already connected to different nets, this directive will result in an error.

4. disconnect {pin}. This directive causes the ECO tool 30 to disconnect a pin. This should be done before reconnecting the pin to something else.

5. create_instance {instancename cellname}. This directive causes the ECO tool 30 to create a new instance of the specified type (e.g., a NAND gate).

6. delete_net {netname}. This directive causes the ECO tool 30 to delete the entire specified net, including the logical and physical models of the net.

7. delete_route {netname}. This command causes the ECO tool 30 to delete the physical connectivity for the given net. To ensure that the net is simply rerouted without changing the logical connectivity, the delete_route directive should be used instead of the delete_net directive.

8. delete_instance {instname}. This directive causes the ECO tool 30 to delete the specified instance.

9. change_inst_type {instname newinsttype {force_placement 0}}. This directive causes the ECO tool 30 to change the type of a gate. The ports of the gate replaced must match the ports of the gate that replaces it. This directive is typically used for upsizing a gate. The force_placement is an option to the change_inst_type directive and indicates to the ECO tool 30 that the placement of the new gate must be the same as the placement of the old gate. When doing upsizing, using the force_placement option is not recommended as the new gate is bigger than the old gate. The force_placement option is typically used when more complex behavior is needed from the ECO tool 30, such as removing an adjacent fill cell and then upsizing the gate.

10. buffer_pin {pin buffer_type}. This directive causes the ECO tool 30 to place a buffer near the specified pin. It handles both input and output pins. In both cases, the placement hint for the new gate defaults to the given pin.

11. create_net {netname}. This directive causes the ECO tool 30 to create a new net.

12. place_instance {instname x y orient}. This directive causes the ECO tool 30 to place a given instance absolutely. The coordinates of the lower left corner of the cell are specified by x and y, and the term “orient” refers to the orientation of the cell.

13. move_instance {instname x y orient}. This directive causes the ECO tool 30 to move a given instance absolutely and will delete any routes connected to that instance. It should be noted that the only difference between the move_instance and place_instance directives is that the move_instance directive will causes any routes associated with the specified instance to be deleted. As such, the move_instance directive is intended for use when the instance being moved was previously routed. The place_instance directive is typically used for placing new gates introduced in the ECO.

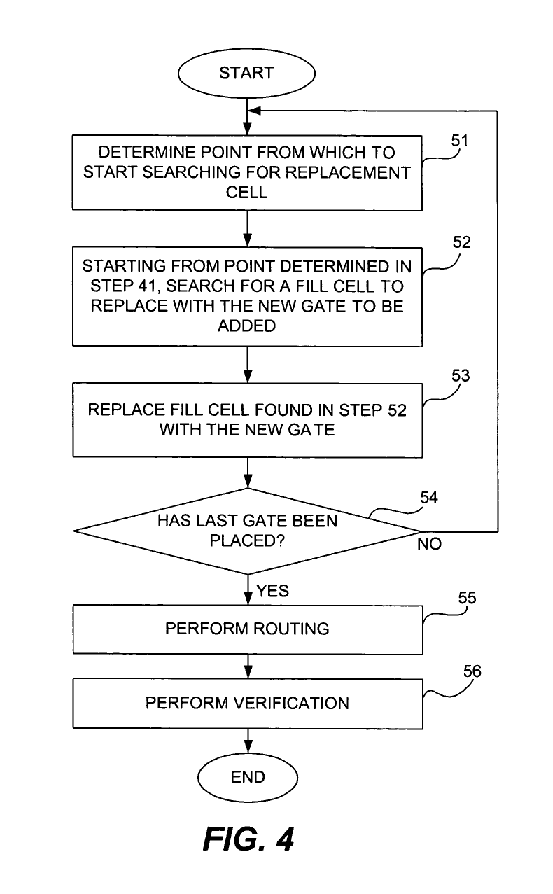

The manner in which the ECO tool 30 finds a placement location in accordance with an embodiment will now be described with reference to the flow chart illustrated in FIG. 4. For each new gate to be placed, the ECO tool 30 determines a “desired” point in the design at which to begin placement, as represented by block 51. If a placement “hint” was given by the designer by using the aforementioned placement_hint or placement_hint_inst directives, then that point is treated by the ECO tool 30 as the “desired” point. If an absolute placement location is given by using the place_instance directive, the ECO tool 30 will use the x,y position specified by the designer as the final placement for that gate. In this case the ECO tool 30 will go on to the next gate without searching. If neither a placement hint nor an absolute placement location is provided to the ECO tool 30, the ECO tool 30 will calculate a reasonable placement point to use as the desired point. Then, starting from the desired point, the ECO tool 30 searches for a fill cell to replace with the new gate to be added, as indicated by block 52. During this step, the ECO tool 30 preferably selects the fill cell nearest to the starting point that meets the following criteria:
1. The fill cell is within a given distance (set by the designer); and
2. The fill cell is at least as large as the gate to be placed.
   The fill cell found in step 52 is then replaced with the gate being added, as indicated by block 53. After placement has been performed by the ECO tool 30 for all of the gates being added, routing for the new gates is performed, as indicated by blocks 54 and 55. After routing has been performed, the modified design is verified, as indicated by block 56.

It should also be noted that the ECO tool 30 of the present invention preferably does not change the placement of any gates unless instructed by the designer. Although some currently available placement tools provide ECO capabilities, such tools use previously placed elements as a starting point and then change both the placement of gates specified by the designer as well as the placement of other gates not specified by the designer. As a result, the confidence that the new design will pass quality checks during the verification process decreases as the difference between the new placement and the old placement increases.

Typically, the ECO tool 30 receives many different directives, i.e., a list of directives. Some of these directives implicitly create a placement task, and some (place_instance and move_instance) explicitly create a placement task. There are other tasks implicitly or explicitly created, such as, for example, deleting routes, etc. The placement task is the most difficult, however, and is correspondingly given the varying levels of control to assist the user. The placement tasks typically are created as the result of many of those directives. The following is an example of an ECO control file that might be input to the ECO tool 30:

1. disconnect U933/Q

2. delete_instance U322

3. create_instance Ueco_0 nand

4. connect U933/Q Ueco_0/A

5. buffer_pin ram32_1/dout21

6. move_instance U333 43 54 N

7. create_instance Ueco_1 nor

8. place_instance Ueco_1 232 11 FS

Directives 1, 2, and 4 do not create any placement events. They will, however, require changes to the logical and physical design (the old route to the disconnected pin will be deleted, as will the U322 instance; there will need to be a new route made between pin U933/Q and Ueco_0/A). Directive 3 creates an implicit placement task (a new instance, Ueco_0 now exists and needs to be placed). Similarly, directive 5 also creates a new buffer that needs to be placed.

Directive 6 creates an explicit placement task. However, this task has been fully specified by the designer. The steps in FIG. 4 associated with searching for a placement location need not be followed in this case, as we do not search for a fill cell in this case because the ECO tool 30 has been given a direct placement order. Directive 7 creates an implicit placement task (Ueco_1 is to be placed). However, directive 8 explicitly takes care of this one also, so this gate will also not need to go through the process of searching for a fill cell. The hint directives can be used to guide implicitly created placement tasks. They simply affect what the desired point is, as described above with reference to FIG. 4.

While the present invention has been described with reference to particular embodiments, it will be understood that the present invention is not limited to these embodiments. For example, although the ECO tool 30 of the present invention has been described as being implemented in software, it may instead be implemented as hardware or as a combination of hardware and software. Other variations may be made to the embodiments described herein and all such variations are within the scope of the present invention.

What is claimed is:

1. An apparatus for making changes to an integrated circuit (IC) design, the apparatus comprising:
an engineering change order (ECO) tool configured to receive at least one directive describing a modification to be made to a previously placed, routed and verified IC design, the ECO tool being configured to automatically perform one or more engineering change order (ECO) tasks on the IC design in accordance with the received directive(s).

2. The apparatus of claim 1, wherein the ECO tool only modifies a portion of the IC design affected by performance of the ECO task.

3. The apparatus of claim 1, wherein the ECO tool comprises a user interface for receiving said at least one directive, said at least one directive being input to the ECO tool by a user.

4. The apparatus of claim 1, wherein the directive is selected from a group of directives, the group comprising:
a first directive that directs the ECO tool to automatically place a specified instance near a specified point in the IC design, and wherein the ECO tool automatically determines exactly where the specified instance will be placed in the design using the specified point as a starting point;
a second directive that directs the ECO tool to place a specified instance near a location in the design where a different instance has been placed; and
a third directive that directs the ECO tool to place a specified instance at a specified position in the design.

5. The apparatus of claim 4, wherein the group further comprises:
a fourth directive that directs the ECO tool to disconnect a specified pin;
a fifth directive that directs the ECO tool to create a new instance of a specified type;
a sixth directive that directs the ECO tool to delete a specified net;
a seventh directive that directs the ECO tool to delete routed shapes for a specified net;
an eighth directive that directs the ECO tool to delete a specified instance;
a ninth directive that directs the ECO tool to changes a type of a specified gate;
a tenth directive that directs the ECO tool to place a buffer near a specified pin;
an eleventh directive that directs the ECO tool to create a specified new net; and
a twelfth directive that directs the ECO tool to move a specified instance to a specified placement position in the design and to delete any routes connected to the specified instance being moved.

6. The apparatus of claim 1, further comprising:
a routing tool, wherein when the ECO tool performs the ECO task, the ECO tool generates a file that is suitable for processing by a routing tool, and wherein the routing tool only performs routing identified in the file.

7. The apparatus of claim 2, wherein the ECO tool is a software program comprising instructions for performing an IC design modification algorithm, the algorithm receiving a file containing a list of said at least one directive, the algorithm performing said one or more tasks, the file being input to the ECO tool by a user via a user interface of the ECO tool.

8. The apparatus of claim 7, wherein the software program also comprises instructions for performing a routing algorithm, the routing algorithm only performing routing for one or more portions of the IC design that have been modified by the ECO tool.

9. The apparatus of claim 2, wherein the ECO tool is also configured to perform rules checking to determine whether the portion of the IC design modified by the ECO tool follows certain rules.

10. The apparatus of claim 9, wherein when the ECO tool performs rules checking, the ECO tool determines whether a modification made to the IC design has resulted in one or more short circuits that need to be routed.

11. A method for modifying an integrated circuit (IC) design that has previously been placed, routed and verified, the method comprising:
receiving the IC design that is to be modified in an engineering change order (ECO) tool;
receiving at least one directive in the ECO tool, said at least one directive describing one or more ECO tasks to be performed by the ECO tool; and
automatically modifying the IC design with the ECO tool by performing said one or more ECO tasks.

12. The method of claim 11, wherein the ECO tool only modifies a portion of the IC design affected by performance of said one or more ECO tasks.

13. The method of claim 11, wherein said at least one directive is entered into a user interface of the ECO tool by a user.

14. The method of claim 11, wherein said at least one directive is selected from a group of directives, the group comprising:
a first directive that directs the ECO tool to automatically place a specified instance near a specified point in the IC design, and wherein the ECO tool automatically determines exactly where the specified instance will be placed in the design using the specified point as a starting point;
a second directive that directs the ECO tool to place a specified instance near a location in the design where a different instance is placed; and
a third directive that directs the ECO tool to place a specified instance at a specified placement position in the design.

15. The method of claim 14, wherein the group further comprises:
a fourth directive that directs the ECO tool to disconnect a specified pin;
a fifth directive that directs the ECO tool create a new instance of a specified type;
a sixth directive that directs the ECO tool to delete a specified net;
a seventh directive that directs the ECO tool to delete routed shapes for a specified net;
an eighth directive that directs the ECO tool to delete a specified instance;
a ninth directive that directs the ECO tool to change a type of a specified gate;
a tenth directive that directs the ECO tool to place a buffer near a specified pin;
an eleventh directive that directs the ECO tool to create a specified new net; and
a twelfth directive that directs the ECO tool to move a specified instance to a specified placement position in the design and to delete any routes connected to the specified instance being moved.

16. The method of claim 15, further comprising:
performing routing for one or more design elements that have been placed by the ECO tool.

17. The method of claim 15, wherein the ECO tool is a software program comprising instructions for performing an IC design modification algorithm, the algorithm performing said one or more task described by said at least one directive.

18. The method of claim 17, wherein the software program also comprises instructions for performing a routing algorithm, the routing algorithm only performing routing for one or more portions of the IC design that have been modified by the IC design modification algorithm.

19. A method for modifying an integrated circuit (IC) design that has previously been placed, routed and verified, the method comprising:
receiving at least one directive describing a placement task to be performed on the IC design;
determining from the received directive a desired point in the IC design at which to begin placement;
selecting a fill cell that is nearest to the desired point; and
placing a design element specified by the directive in the fill cell.

20. The method of claim 19, wherein the step of selecting a fill cell includes:
selecting a fill cell that is nearest to the desired point and that is within a selected distance from the desired point and that is at least as large as the design element to be placed in the fill cell.

21. A computer-readable medium having a computer program embedded thereon for performing a placement process on an integrated circuit (IC) design that has previously been placed, routed and verified, the computer-readable medium comprising:
a first code segment for receiving the previously placed, routed and verified IC design;
a second code segment for receiving at least one directive describing one or more ECO tasks to be performed on the IC design; and
a third code segment for automatically modifying the IC design by performing said one or more tasks described by the directive.
